(19) United States
(12) Patent Application Publication
(10) Pub. No.: US 2025/0122950 A1
(43) Pub. Date: Apr. 17, 2025

(54) INTEGRATED ELECTRICAL AND MECHANICAL POSITION INDICATOR IN VALVE ACTUATOR

(71) Applicant: Tri-Tec Manufacturing, LLC, Kent, WA (US)

(72) Inventors: Gregory James CHAMPOUX, Kent, WA (US); Jeffrey Edward IP, Kent, WA (US); Nathan NICHOLSON, Kent, WA (US); Noah John CLEARY, Kent, WA (US)

(73) Assignee: Tri-Tec Manufacturing, LLC, Kent, WA (US)

(21) Appl. No.: 18/899,594

(22) Filed: Sep. 27, 2024

Related U.S. Application Data
(60) Provisional application No. 63/589,957, filed on Oct. 12, 2023.

(51) Int. Cl. F16K 37/00; F16K 31/53

(52) U.S. Cl. CPC F16K 37/0041; F16K 31/53; F16K 37/0016

(57) ABSTRACT

A device for a valve actuator directed to an integrated assembly having an electrical position indicator and mechanical position indicator is provided. The electrical position indicator and the mechanical position indicator are coupled together along a shaft. An actuator output gear is positioned adjacent to the shaft. The shaft includes a first end having the electrical position indicator, and a second end having the mechanical position indicator. A gear is positioned on the shaft between the electrical position indicator and the mechanical position indicator. The device further includes a slip clutch. A housing that surrounds the actuator output gear and the shaft is also provided.

### STATEMENT OF GOVERNMENT INTEREST

This invention was made with government support under N00024-18-C-2130 awarded by the Department of Defense. The government has certain rights in the invention.

### BACKGROUND

### Technical Field

The present disclosure is directed to an integrated electrical position indicator at a first end of a shaft and a mechanical position indicator at a second end of the shaft with a worm or spur gear positioned between the first and second end that integrates with an actuator output of a valve actuator.

### Description of the Related Art

In fluid transfer applications, several devices are known that allow for the indication of a valve actuator position. Among these are electrical position indicators (EPI) and mechanical position indicators (MPI). The primary purpose of these devices is to provide an indication, whether by electrical feedback or visual confirmation from a user, that a valve is in an open or closed position. The indicators have the capability to provide a certain percentage open or closed that may be visually observed by the user or communicated via electronic signal to the user. The valve actuator position indicators enable the user to accurately perform initial set up, whether setting limits on the valve positions in a manufacturing setting, or in the field when installing or troubleshooting the valve actuator.

Current designs include an electrical position indicator, such as a rotary potentiometer coupled to a valve actuator at a first location and a mechanical position indicator coupled to the valve actuator in a separate and distinct location from the electrical position indicator. Readings from the electrical position indicator and the mechanical position indicator are decoupled and separate from each other. The respective positions of the indicators within the actuator negate the prospect of gathering the readings simultaneously. For example, if a dial was to turn one direction, it would be difficult to simultaneously, or quickly, determine the actual position of the valve relative to the rotary potentiometer.

The dial and the needle in current designs are positioned in the same location on the diaphragm, while the potentiometer is located on an upstream portion of the housing of the actuator. This current design can lead to inaccurate readings and creates unnecessary difficulty while attempting to access the indicators for initial setup, reading of valve positions, and troubleshooting.

### BRIEF SUMMARY

Embodiments of the electrical position indicator and mechanical position indicator disclosed herein contribute to improved accessibility of the indicator devices and enables simultaneous accurate readings of valve positions by coupling both the dial and the potentiometer along a main shaft. This can help expedite initial setup during manufacturing and during installation on location, and further contributes to an unobtrusive configuration of the electrical position indicator and mechanical position indicator. For example, during initial setup or during maintenance adjustments, this unobtrusive configuration provides little to no disassembly in order to adjust feedback devices such as electronic position indicators (EPI). The position of the main shaft with respect to walls of the housing allows a technician to make adjustments without removing the housing. This unobtrusive design can significantly reduce downtime of the valve actuator while performing preventative maintenance or troubleshooting other issues that may arise during operation of the valve.

An embodiment of a device may be summarized as including: a valve actuator; an actuator output gear; a shaft that includes a first end that is opposite to a second end; an electrical position indicator at the first end of the shaft; a mechanical position indicator at the second end of the shaft; and a first gear on the shaft between the first and second end, and the first gear is configured to interact with the actuator output gear.

The device may include a housing around the actuator output gear and the shaft, with the mechanical position indicator being outside of the housing. The shaft may include an extension between the first end and the second end, that is centrally positioned and is configured to support a gear on the shaft. The shaft may also include a first dimension along a first direction between the first end and the second end, and the extension may include a second dimension in a second direction that is transverse to the first direction, with the second dimension being less than the first dimension. The device may further include a slip clutch on the shaft, wherein the slip clutch is closer to the first end of the shaft than the second end of the shaft. The first gear may be between the slip clutch and the second end of the shaft.

Another embodiment of the device may be summarized as including: a valve actuator that may include an actuator output gear; a shaft; a gear on the shaft; a slip clutch on the shaft; an electrical position indicator on the shaft; a coupler on the shaft; a mechanical position indicator on the shaft; and a mechanical position indicator on the shaft, with the gear between the mechanical position indicator and the electrical position indicator. The coupler may be adjacent to electrical position indicator and may be further from the second end of the shaft than the slip clutch. The coupler may be between the slip clutch and the electrical position indicator. The shaft may include an intermediate extension that is closer to the mechanical position indicator than the electrical position indicator. The gear may be positioned between the slip clutch and the intermediate extension.

Another embodiment of the device may be summarized as including: a valve, a valve actuator output gear having first threads, the valve actuator output gear being coupled to the valve; a gear having second threads that are in contact with ones of the first threads; a shaft wherein the gear may be positioned on the shaft, with the shaft including: an electrical position indicator at a first end of the shaft; and a mechanical position indicator at a second end of the shaft, the mechanical position indicator and electrical position indicator being configured to simultaneously provide readings indicative of a position of the valve.

The device may further include a clutch positioned on the shaft and between the electrical position indicator and the gear. The electrical position indicator may include a first portion and a second portion, the second portion of the electrical position indicator having a slot configured to receive the first end of the shaft. The device may also include a coupling mechanism positioned at the first end of the shaft, the coupling mechanism substantially surrounding the bottom portion of the electrical position indicator. The clutch may be a slip clutch having two washers. The device may further include a housing that includes a top portion and a bottom portion, and the housing may surround the valve actuator output gear. The electrical position indicator may protrude out a first side of the housing in some embodiments and in others, the electrical position indicatory may be enclosed within the housing. The mechanical position indicator is flush with a second side of the housing. The shaft may include an integrally formed threaded portion, wherein the threaded portion is closer to the gear than to the electrical position indicator. The clutch may also be positioned on the threaded portion of the shaft.

### BRIEF DESCRIPTION OF THE SEVERAL VIEWS OF THE DRAWINGS

FIG. 1 shows a valve actuator that includes an integrated electrical position indicator and a mechanical position indicator on a shaft.

FIG. 2 shows an alternative embodiment of a valve actuator that includes an integrated electrical position indicator and a mechanical position indicator on a shaft.

FIG. 3 shows an enhanced view of a coupling portion of the shaft coupled to the electrical position indicator according to an embodiment.

FIG. 4 shows an enhanced view of a coupling mechanism adjacent to the electrical position indicator.

FIG. 5 shows a cross-sectional view of the shaft according to an embodiment.

FIG. 6 shows a perspective view of a housing having an embodiment of the integrated electrical position indicator and the mechanical position indicator on the shaft.

FIG. 7 shows an exploded view of the housing of FIG. 6.

FIG. 8 shows a perspective view of an alternative embodiment of a housing for an embodiment of the integrated electrical position indicator and the mechanical position indicator on a shaft.

### DETAILED DESCRIPTION

In many fluid transfer applications, an actuator and valve are installed with piping to control the flow of the fluid. The valve's relative position can be determined electronically and mechanically using the actuator components described herein.

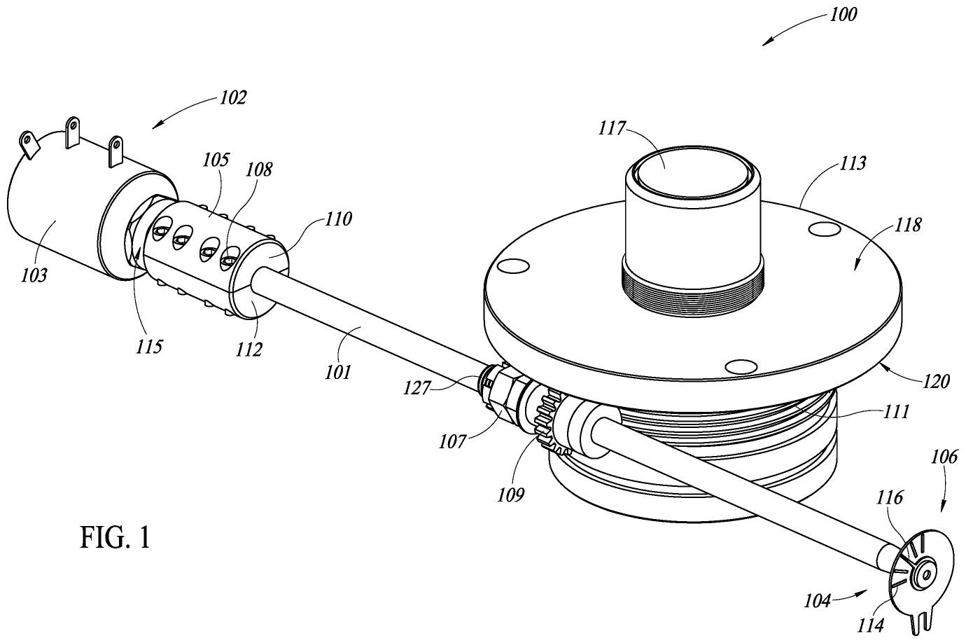

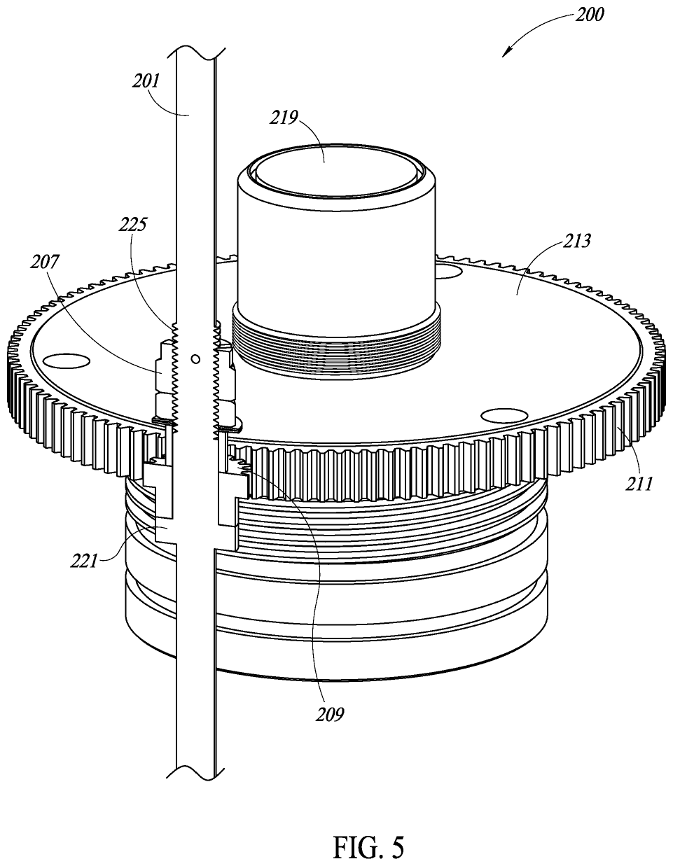

FIG. 1 shows a perspective view of a valve actuator 100 having an integrated electrical position indicator (EPI) and mechanical position indicator (MPI) subassembly according to one embodiment of the present disclosure. The subassembly includes a gear-driven shaft 101 having a first end 102 and a second end 104, with the first end 102 positioned opposite to the second end 104 along the shaft 101. The shaft 101 is configured as one single piece with a gear 109, which may be a worm gear, positioned along the shaft 101 between the first end 102 and the second end 104. The shaft 101 is configured with a perpendicular portion built into the shaft 101 (shown in FIG. 5) on which the gear 109 is positioned on top.

The shaft 101 includes a threaded portion 127 that is closer to the first end 102 than the second end 104 of the shaft 101. A clutch or slip clutch 107 is screwed onto the threaded portion 127 and is adjacent to the gear 109. The slip clutch 107 is made of two washers that are secured between the gear and the fastening nuts to ensure that the gear 109 will remain in place while the shaft 101 rotates. The washers may be some other suitable fastener or spring.

The subassembly further includes an Electrical Position Indicator (EPI) 103 and a Mechanical Position Indicator (MPI) 106 coupled on the ends of the shaft 101, allowing the entire subassembly to be installed as a single unit, which results in easier installation and maintenance. The EPI 103 is positioned on the first end 102 of the shaft 101, and the MPI 106 is located on the second end 104 of the shaft. The EPI 103 increases or decreases resistance depending on the rotation of its shaft. The EPI 103 is attached to a circuit board (not shown) that measures the fluctuating voltage and determines the position of the valve. Each rotation of the EPI 103 results in a valve position reading, a feature particularly useful in many multi-turn valve applications.

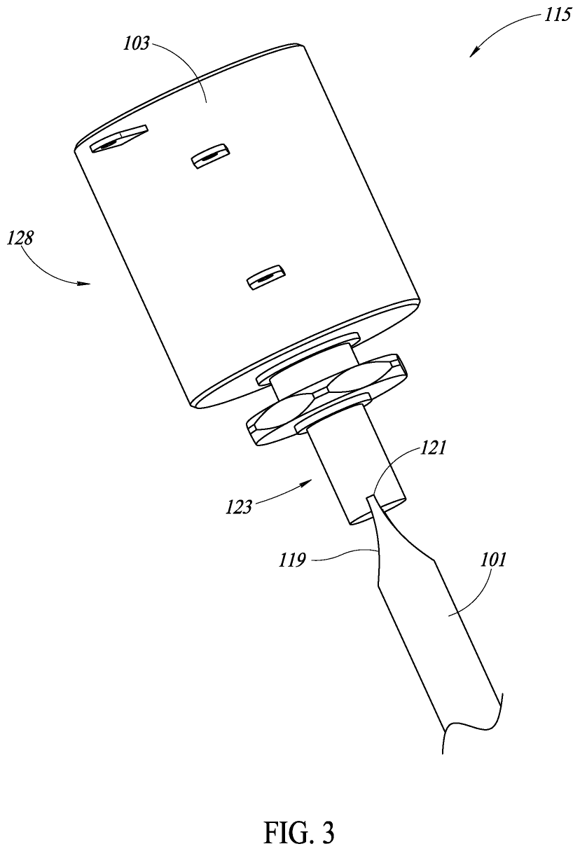

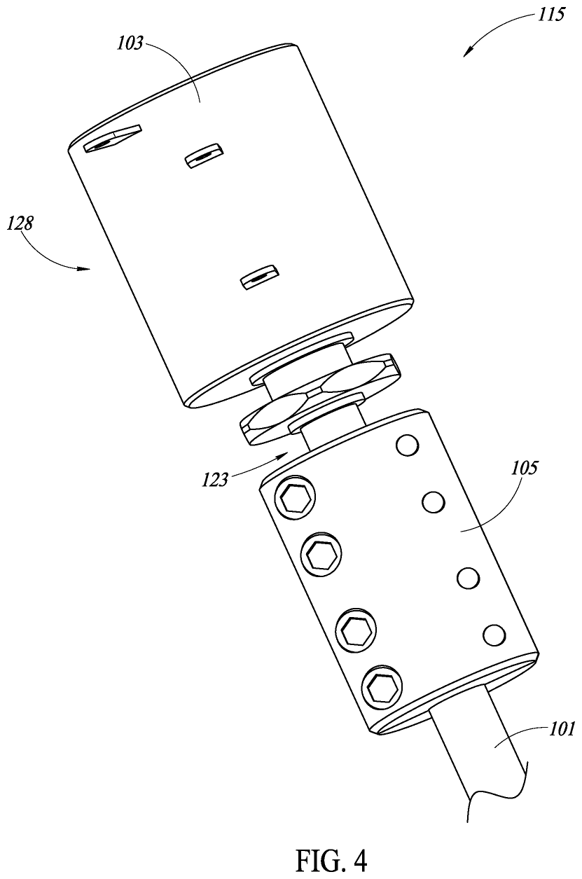

In this embodiment, the EPI 103 is configured as a rotary potentiometer. The EPI 103 provides analog or digital electronic feedback via circuitry to the actuator's electronic controller for the purposes of measuring and controlling the position of the actuator's output. The EPI 103 is comprised of two portions, one of which includes a coupling portion 115 that will be described in greater detail below (FIGS. 3 and 4). The EPI 103 and shaft 101 are held in place via a coupling mechanism or coupler 105 that substantially covers the coupling portion 115 of the EPI 103. The coupler 105 may be arranged in a way that allows for a plurality of screws 108 to couple a first portion 110 and a second portion 112 of the coupler 105 together, further securing the EPI 103 to the shaft 101. However, it is appreciated that the coupler 105 may be configured in a manner similar to other coupling mechanisms that are capable of attaching and holding the EPI 103 in place along the first end 102 of the shaft 101. For example, the coupler 105 as shown in FIG. 1 ensures that the EPI 103 remains locked and secured onto the first end 102 of the shaft 101 in such a manner that the EPI 103 does not separate from the shaft 101 or come apart during operation.

The MPI 106 is positioned on the second end 104 of the shaft 101, opposite to the first end 102 and the EPI 103, and includes a dial 114 and a needle 116. The dial 114 is completely stationary and in the embodiment shown in FIG. 1, configured as an O-shaped member at the tip of the second end 104 of the shaft 101. The needle 116 sits on the dial 114 and is fixed to the shaft 101. The needle 116 has the capability to rotate with the shaft 101. For example, as the actuator and gears engage, the shaft 101 will rotate and will indicate on the dial 114 where the valve will be situated with the respect to open and close operations. Thus, the MPI 106 visually displays the position of the valve. In other words, the rotation of the needle 116 along the dial 114 indicates the valve position: “Open” at the beginning point and “Closed” at the endpoint. Other indentations may be used to indicate the status of the valve or the valve position, such as percentages or decimals, that are clearly visible to the user. This creates an easier initial set up during installation or during manufacturing in preparation of shipments. For example, during assembly, the MPI 106 can be manually maneuvered to match the status that is indicative of the current position of the valve.

An actuator output 113 is positioned perpendicular to the shaft 101 between the first end 102 and the second end 104. The actuator output 113 includes a screw cap 117 on a top portion 118, and a worm screw thread 111 integrally formed on a lower portion 120. The screw thread 111 meshes with the gear 109 on the shaft 101 and is configured to drive against the gear 109. For example, when the valve actuator 100 receives a signal to open or close a valve (not shown), the actuator output 113 rotates in a certain direction which then rotates the screw thread 111. In turn, the screw thread 111 engages with the gear 109 on the shaft 101 and forces the shaft 101 to rotate and turn both the needle 116 and the rotary potentiometer together. This allows readings of the EPI 103 and MPI 106 to be coupled and provided simultaneously, thus allowing for real time, accurate identification of a position of a valve.

In some instances, if a situation arises that requires the user to adjust the dial 114 or the EPI 103, the slip clutch 107 is configured in a manner that engages at a certain torque allowing the user the capability to turn the dial 114 and rotary potentiometer simultaneously, without having to move the entire valve (i.e., opening or closing the valve). Additionally, the position of the slip clutch 107 on the shaft 101 may also change relative to where the actuator output 113 is placed. For example, during initial set up in the manufacturing stage, the valve actuator requires a user to establish electrical limits to the potentiometer, thus providing a signal that allows the actuator to know what position is open for the valve or closed for the valve. The integrated EPI/MPI assembly described herein advantageously provides the ability to turn the dial 114 to open or close and readjust the electrical limits to get the valve actuator in the appropriate position so it can open and close the valve properly.

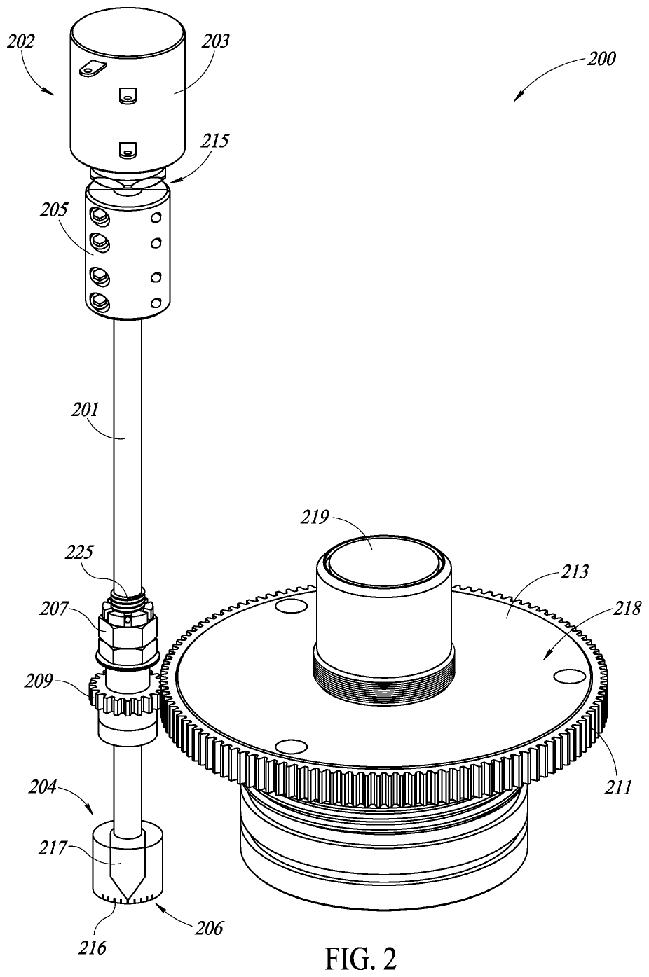

FIG. 2 shows a perspective view of an alternative embodiment of a valve actuator 200 having an EPI/MPI subassembly. Many of the same parts and features shown in FIG. 1 are similar to the parts and features shown in FIG. 2. For example, the valve actuator 200 includes a gear-driven shaft 201 having a first end 202 and a second end 204, with the first end 202 positioned opposite to the second end 204 along the shaft 201. The shaft 201 is configured as one single piece with a gear 209, which can be a spur gear, positioned along the shaft 201 between the first end 202 and the second end 204. The shaft 201 further includes a perpendicular portion or register built into the shaft 201 on which the gear 209 is positioned on.

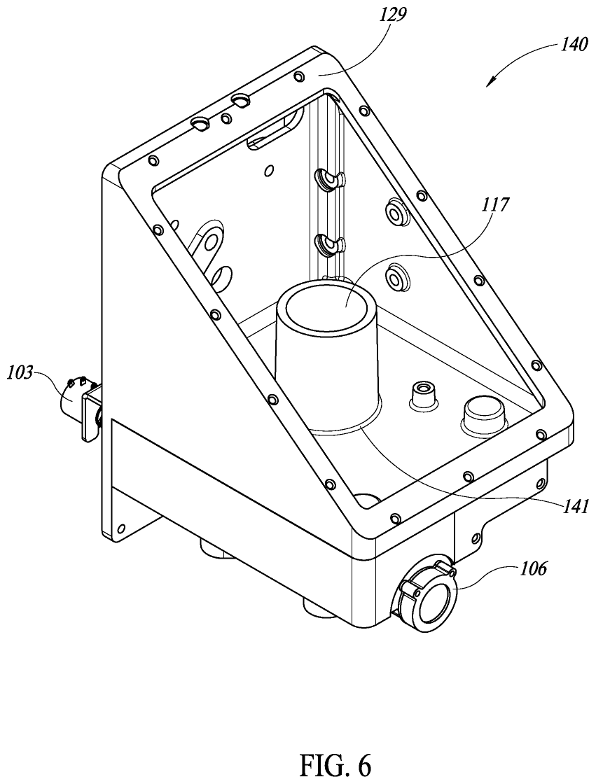

The shaft 201 includes a threaded portion 225 that is positioned closer to the second end 204 than the first end 202. This is partially due to the shaft 201 having a longer portion extending towards the first end 202, and a shorter portion extending towards the second end 204, the longer portion having a dimension greater than the shorter portion. The shaft 201 encompassing a shorter length enables variability with regard to various housing configurations that will contain or house the valve actuator, resulting in ease of visibility for the user. However, certain features of the disclosure described herein, such as the shaft 201 length, the EPI/MPI positions on the shaft 201 in relation to the actuator housings, are relative to the design of the actuator and the particular needs of the user. An example of this will be described in greater detail with respect to FIGS. 6-8. The shaft 201 further includes a clutch or slip clutch 207 that is positioned onto the threaded portion 225 and is adjacent to the gear 209. The slip clutch 207 is made of two washers that are between the gear and the fastening nuts.

As similarly illustrated in FIG. 1, the subassembly includes an EPI 203 on the first end 202, and a MPI 206 on the second end 204, with both indicators coupled along the shaft 201. The EPI 203 is comprised of two portions, one of which includes a coupling portion 215, similar to the coupling portion 115 described in further detail below. The EPI 203 is held in place by a coupler 205 that is attached to the coupling portion 215 of the EPI 203. The coupler 205 ensures that the EPI 203 will remain locked to the shaft 201 when the valve and/or valve actuator is in operation.

The MPI 206 is positioned at the second end 204 of the shaft 201, opposite to the EPI 203 on the first end 202. The MPI 206 includes a needle 217 and a dial 216. The needle 217 is positioned on the dial 216 but is fixed to the shaft 201 and configured to rotate as the shaft 201 rotates. Thus, the needle 217 can visibly display the position of the valve to the user. An actuator output 213 is positioned parallel to the shaft 201 and is secured tightly to a spur gear 211. The actuator output 213 includes a screw cap 219 on a top portion 218, and a spur gear 211 below the screw cap 219. The gear 211 meshes with the gear 209 on the shaft 201 and is configured to drive against the gear 209 during rotation of the actuator output 213.

FIGS. 3 and 4 show an enlarged perspective view of the coupling portion 115 of the valve actuator 100 as shown in FIG. 1. In FIG. 3, the coupling portion 115 includes the EPI 103 on the second end 102 of the shaft 101. The EPI 103 is composed of two portions, a potentiometer upper portion 128 and a potentiometer lower portion 123 that extends into the coupler 105. The potentiometer lower portion 123 includes a slot 121 that is configured to receive the first end 102 of the shaft 101. In some embodiments, the first end 102 of the shaft 101 is formed in a wedge-shaped flat tip 119, as shown in FIG. 3. The wedge-shaped flat tip 119 is used to insert the shaft 101 into the slot 121 of the potentiometer lower portion 123, ensuring that that the EPI 103 and the shaft 101 remain coupled together during operation.

When the wedge-shaped flat tip 119 of the shaft 101 is securely inserted into the slot 121 of the potentiometer lower portion 123, the coupler 105 is externally applied to the coupling region 115. The coupler 105 is constructed in a manner that substantially encapsulates the potentiometer lower portion 123 and the first end 102 of the shaft 101 securing two parts together via a plurality of screws 108. Tightening the screws 108 into the coupler 105 will clamp the coupler 105 around the connecting pieces and couple the two coupler parts together. However, alternative coupling mechanisms may likewise be used to secure the first end 102 and the potentiometer lower portion 123 together.

FIG. 5 shows a cross-sectional view of the shaft 201 and spur-gear embodiment of the valve actuator 200 as shown in FIG. 2. The shaft 201 is shown as a singular elongated piece with the threaded portion 225 integrally formed into the shaft 201. The slip clutch 207 having the two washers between the gear 209 and the nuts 207. The gear 209 is situated on a horizontal extension 221 of the shaft 201. The horizontal extension 221 is positioned closer to the second end 104 of the shaft 201 than to the first end 102. The horizontal extension or register 221 is formed into the shaft 201 and allows the gear 209 to rest on top of while engaging with the gear 211 of the actuator output 213. This configuration enables greater stability of the EPI/MPI subassembly during operation of the valve actuator 200.

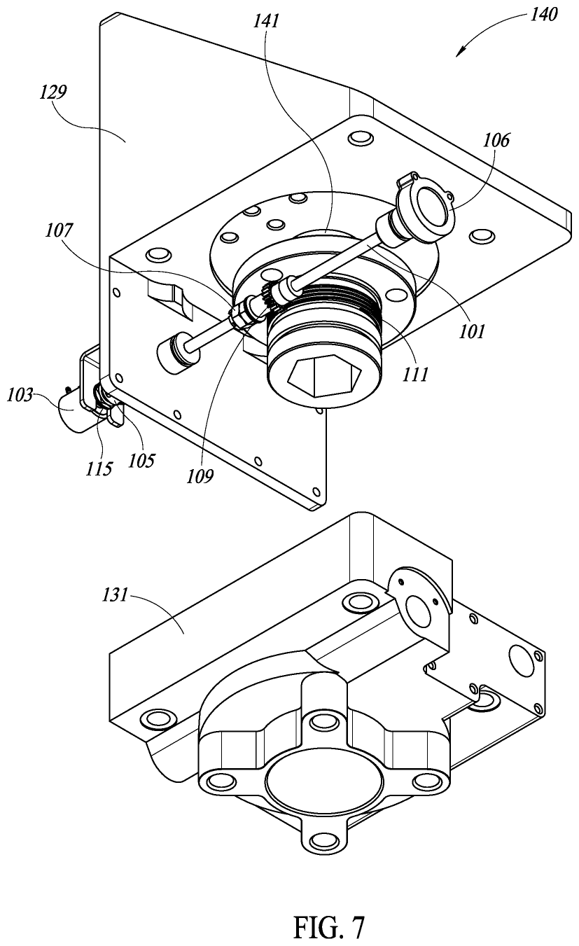

FIGS. 6 and 7 show a perspective view of a housing 140 used to cover or house the integrated EPI/MPI subassembly shown in FIG. 1. The housing 140 includes a top portion 129 and a bottom portion 131. The top portion 129 includes a hollowed-out center. The base of the top portion 129 of the housing 140 sits on a portion 118 of the actuator output 113. In this embodiment, the housing 140 is shown in a square-like shaped configuration, however in some embodiments the housing 140 may encompass various shapes to meet the specification of the EPI/MPI subassembly embodiment and therefore may not be limited to the design shown in FIGS. 6 and 7. For example, the subassembly having the shorter shaft 101 is integrated into the design of the housing 140 so that the MPI 106 is flush with the wall of the housing 140, and the EPI 103 protrudes away from the housing 140 enabling easy access for readjust of the potentiometer, as previously discussed. In some embodiments, the EPI 103 may not extend out the side of the housing 140, but dependent on the design of the valve actuator, may be secured within the housing 140. Similarly, based upon the preference of the user and/or manufacturer, the MPI 106 may not be flush with the housing 140 but may extend out the side of the housing 140.

FIG. 7 shows a perspective view of the housing 140 with the top portion 129 and the bottom portion 131 separated. The integrated EPI/MPI subassembly is placed within the housing 140, with the screw cap 117 or a portion of the valve actuator 100 inserted through an aperture 141 of the top portion 129. The shaft 101 extends from one side of the housing 140 to an opposite side, with the first end 102 having the EPI 103 protruding through one side, and the second end 104 having the MPI 106 positioned flush with the opposite side. The bottom portion 131 of the housing 140 is coupled to the top portion 129, and configured to cover the integrated EPI/MPI subassembly including the slip clutch 107, the gear 109, and the shaft 101. Once coupled together, the shaft 101 and various parts of the subassembly will remain covered by the bottom portion 131, apart from the EPI 103 and MPI 106 as mentioned above. The bottom portion 131 may encompass a variety of configurations that can cover the subassembly in the manner necessary by the user and may not be limited to shape shown in FIG. 7.

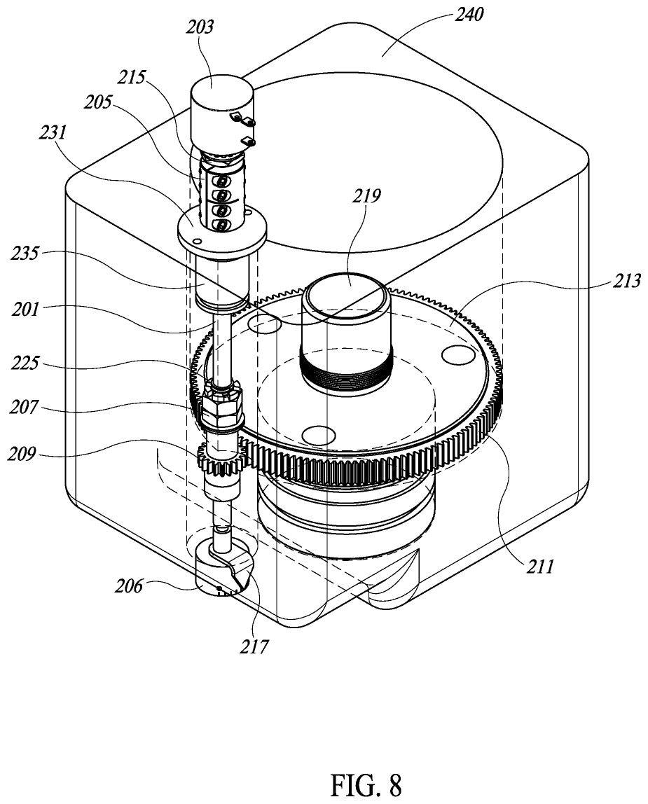

FIG. 8 shows an alternative embodiment of a housing 240 enclosing the valve actuator 200 of FIG. 2. The housing 240 is substantially rectangular-shaped, the housing 240 containing the actuator output 213, and gear 211. The housing 240 partially encapsulates the shaft 201, including the threaded portion 225 having the slip clutch 207, and the gear 209. A coupler extension 235 is positioned within the housing 240 and couples to the coupler 205 via a coupling washer 231 that is abuts with an outer wall of the housing 240. The coupler 205, coupling portion 215, and EPI 203 extend from the outer wall of the housing 240, contributing to convenient readjustment of the EPI 203 or during manufacturing, installation, or maintenance of the valve actuator 200. However, a variety of housing configurations may be used to house or contain the EPI/MPI subassembly and may be dependent on the design of the actuator, the design of the housing itself, or user/manufacturer preference and is not limited to the housing shown in FIG. 8. For example, the arrangement of the EPI 203 in FIG. 8 allows for the EPI 203 to be adjusted without having to open the housing 240 of the actuator.

The second end 204 of the shaft 201 extends through the bottom of the outer wall of the housing 240, making the dial 216 and needle 217 visible. In some embodiments, the second end 204 of the shaft may extend further out from the outer wall of the housing 240 or may be flush with the outer wall of the housing 240. The shaft 201 may be configured in a manner that is convenient and provides the best visibility for the user. Similar to the arrangement of the EPI 203, the MPI 206 being exterior to the housing 240 allows the MPI 206 to be adjusted without having to open the housing 240. This arrangement of the EPI 203 and MPI 206 further provides for the readings to be analyzed simultaneously and also allows for assembly and adjustment of the valve actuator 100, 200 at the same time.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a valve actuator;
an actuator output gear;
a shaft that includes a first end that is opposite a second end;
an electrical position indicator at the first end of the shaft;
a mechanical position indicator at the second end of the shaft; and
a first gear on the shaft between the first and second end, the first gear configured to interact with the actuator output gear.

2. The device of claim 1, comprising a housing around the actuator output gear and the shaft, the mechanical position indicator being outside the housing.

3. The device of claim 1 wherein the shaft includes an extension between the first end and the second end.

4. The device of claim 3 wherein the shaft includes a first dimension along a first direction between the first end and the second end, the extension including a second dimension in a second direction that is transverse to the first direction, the second dimension being less than the first dimension.

5. The device of claim 1, comprising a slip clutch on the shaft, the slip clutch being closer to the first end than the second end.

6. The device of claim 5 wherein the first gear is between the slip clutch and the second end.

7. A device, comprising:
a valve actuator that includes:
an actuator output gear;
a shaft;
a gear on the shaft;
a slip clutch on the shaft;
an electrical position indicator on the shaft;
a coupler on the shaft;
a mechanical position indicator on the shaft, the gear between the mechanical position indicator and the electrical position indicator.

8. The device of claim 7 wherein the coupler is adjacent to the electrical position indicator, the coupler being further from the second end than the slip clutch.

9. The device of claim 7 wherein the coupler is between the slip clutch and the electrical position indicator.

10. The device of claim 9 wherein the shaft includes an intermediate extension that is closer to the mechanical position indicator than the electrical position indicator.

11. The device of claim 10 wherein the gear is between the clutch and the intermediate extension.

12. A device, comprising:
a valve;
a valve actuator output gear having first threads, the valve actuator output gear being coupled to the valve;
a gear having second threads that are in contact with ones of the first threads;
a shaft, the gear being on the shaft, the shaft including:
an electrical position indicator at a first end of the shaft;
a mechanical position indicator at a second end of the shaft, the mechanical position indicator and electrical position indicator being configured to simultaneously provide readings indicative of a position of the valve.

13. The device of claim 12 further comprising a clutch positioned on the shaft between the electrical position indicator and the gear.

14. The device of claim 12 wherein the electrical position indicator comprises a first portion and a second portion, the second portion of the electrical position indicator having a slot configured to receive the first end of the shaft.

15. The device of claim 12 further comprising a coupling mechanism positioned at the first end of the shaft, the coupling mechanism substantially surrounding the bottom portion of the electrical position indicator.

16. The device of claim 13 wherein the clutch is a slip clutch comprising two washers.

17. The device of claim 12 further comprising a housing that includes a top portion and a bottom portion, the housing surrounding the valve actuator output gear.

18. The device of claim 17, wherein the electrical position indicator protrudes out a first side of the housing, and the mechanical position indicator is flush with a second side of the housing.

19. The device of claim 12 wherein the shaft includes an integrally formed threaded portion, the threaded portion closer to the gear than to the electrical position indicator.

20. The device of claim 19, wherein the clutch is positioned on the threaded portion of the shaft.
